(19) United States
(12) Patent Application Publication
(10) Pub. No.: US 2012/0073000 A1
(43) Pub. Date: Mar. 22, 2012

(54) EMBEDDED ANTI-THIEF SYSTEM AND ANTI-THIEF METHOD THEREOF

(75) Inventors: Jang-Ping Sheu, Hsinchu (TW); Yi-Chang Chen, Hsinchu (TW)

(73) Assignee: NATIONAL TSING HUA UNIVERSITY (TAIWAN), Hsinchu (TW)

(21) Appl. No.: 13/040,010

(22) Filed: Mar. 3, 2011

(30) Foreign Application Priority Data
Sep. 17, 2010 (TW) 099131568

(51) Int. Cl. G06F 11/00

(52) U.S. Cl. 726/35

(57) ABSTRACT

The present invention relates to an embedded anti-thief system and a method thereof for executing anti-thief procedures, the embedded anti-thief system comprises: a core firmware module, an embedded system module and a cloud server module, wherein the core firmware module is disposed in a firmware device of a portable computer and capable of automatically inspecting the security status of the portable computer when the portable computer is booted. The embedded system module is disposed on a hard disk device of the portable computer and able to communicate with the core firmware module and the cloud server module, so as to confirm the security status of the portable computer. Through the method, the core firmware module and the embedded system module can be loaded and effectively cooperate with the cloud server module for executing the anti-theft procedures for the portable computer at any time.

### BACKGROUND OF THE INVENTION

1. Technical Field

The present invention relates to an embedded anti-thief system, and more particularly, to an embedded anti-thief system and an anti-thief method thereof, so that, through the monitor of a cloud server module and the execution of a core firmware module and an embedded system module, the user's computer can be prevented from being thieved at any time.

2. Description of Related Art

With the development of computer technology, portable computers are widely be used and provide much convenience to human life, such that people would carry the portable computers anytime and everywhere; however, when people carry the portable computers to a public place, they must notice their portable computers at any time and need to protect the portable computers from being thieved. According to the information provided by the web site of http://www.failsale.com, the report proposed by the Federal Bureau of Investigation (FBI) indicates that one computer would be stole around 53 seconds in the United State, in which, the total number of the stole computers in airports approaches 640,000; moreover, 97% of all the stole computers can not be recovered. In addition, the research report, that Intel entrusts an independent research organization—Ponemon Institute to make, indicates that each of the stole computers causes about 49,246 US dollars losses to the respective company thereof (the research report is obtained from http://communities.intel.com/docs/DOC-3076).

So that, for solving the issue about the portable computers may be stole in the public place, the partial users may use a mechanical computer lock to lock their computers on the top of a table; however, the mechanical computer lock has many drawbacks and shortcomings:
1. Using the mechanical computer lock to lock computers on the table in a public place is unsightly.
2. The mechanical computer lock is easily to be cracked, so it can not prevent the computer from being thieved.
3. The mechanical computer lock can merely lock the computer on a fixing device, such as a table or a pillar.
4. If the user loses the key of the mechanical computer lock, the user will get a trouble.
5. If the computers have been stolen, then it is difficult to recover them.

Accordingly, in order to improve the drawbacks and shortcomings of the mechanical computer lock, an electronic anti-thief lock connecting with an USB port of the computer is proposed. Please refer to FIG. 1, which illustrates a schematic diagram of an electronic anti-thief lock connecting to an USB port of a notebook. As shown in FIG. 1, the electronic anti-thief lock includes: a first sensor 116′, a second sensor 126′, a security switch 119′, and a main body 120′, wherein the first sensor 116′ is disposed in one USB port 118′ of the notebook 110′, and the second sensor 126′ is disposed on an USB plug 122′ of the main body 120′; therefore, when the USB plug 122′ is inserted into the USB port 118′, the first sensor 116′ immediately connects to the second sensor 126′ for starting to execute an anti-thief functionality; thus, once the notebook 110′ is stole, the connection between the first sensor 116′ and the second sensor 126′ is broke and the main body 120′ subsequently makes a warning sound.

As shown in FIG. 1, the shape of the above-mentioned electronic anti-thief lock is designed similar to the shape of a computer periphery device, so that, the electronic anti-thief lock is not unsightly; however, the electronic anti-thief lock still has drawbacks and shortcomings:
A. When removing the USB plug 122′ from the USB port 118′, the user may inadvertently make the warning sound if the security switch is not stopped in advance.
B. The way to stop the anti-thief functionality of the electronic anti-thief lock is just switching the security switch 119′; so, if the thief knows that, then the electronic anti-thief lock loses the anti-thief efficacy.
C. Inheriting to above point B, the main body 120′ and the notebook 110′ may be stole together even if the thief is not aware that the way to stop the anti-thief functionality of the electronic anti-thief lock is just switching the security switch 119′.
D. If the notebook 110′ has been stolen, then it is hard to be recovered.

Thus, through above descriptions, it is easily to know that the mechanical computer lock and the electronic anti-thief lock have many shortcomings and drawbacks; accordingly, for this reason, the inventor of the present application has made great efforts to make inventive research thereon and eventually provided an embedded anti-thief system and an anti-thief thereof, so as to provide a solution for people to prevent the computers from theft.

### BRIEF SUMMARY OF THE INVENTION

The primary objective of the present invention is to provide an embedded anti-thief system, in which, a core firmware module and an embedded system module are respectively disposed in a firmware and a hard disk device of a portable computer, so as to detect the security status of the portable computer; moreover, the IP of the portable computer is simultaneously monitored by a cloud server module, so that, the portable computer is able to be prevented from being thieved.

The second objective of the present invention is to provide an anti-thief method for an embedded anti-thief system, in which, through the anti-thief method, a core firmware module and an embedded system module are automatically loaded when a portable computer is booted, so that the core firmware module and the embedded system module are able to cooperate with a cloud server module, so as to execute an anti-thief procedure for the portable computer.

Accordingly, to achieve the abovementioned primary objective, the inventor proposes an embedded anti-thief system, capable of being installed in a portable computer, comprising:

a core firmware module, being disposed in a firmware device of the portable computer, wherein when the portable computer is booted, the core firmware module is able to execute a first step inspection for the security status of the portable computer;

an embedded system module, disposed in a hard disk device and an extended firmware device of the portable computer, wherein when the core firmware module inspects that the portable computer is in an insecurity status, the embedded system module is immediately loaded and executed; and

a cloud server module, able to communicate with the embedded system module through the Internet, wherein when the portable computer is in the insecurity status, the embedded system module immediately unloads an IP data, a GPS data, an important backup data, a video data, and a local time data of the portable computer to the cloud server module, after that the cloud server module returns a verification code to the embedded system module, then, the embedded system module executes a second step inspection for the security status of the portable computer.

Moreover, to achieve the abovementioned primary objective, the inventor proposes an anti-thief method for the embedded anti-thief system, the anti-thief method comprises the steps of:

(1) booting a portable computer; (2) loading a core firmware module; (3) establishing an operation environment by the core firmware module; (4) executing a first step inspection for the security status of the portable computer by the core firmware module; (5) determining whether the portable computer is in an insecurity status, if yes, proceeding to step (6), otherwise, proceeding to step (13); (6) loading an embedded system module; (7) executing the embedded system module; (8) uploading an IP data, a GPS data, an important backup data, a video data, and a local time data of the portable computer to a cloud server module by the embedded system module; (9) updating the data in the cloud server module; (10) returning a verification code to the embedded system module by the cloud server module; (11) executing a second step inspection for the security status of the portable computer by the embedded system module; (12) determining whether the portable computer is in a security status, if yes, proceeding to step (13), otherwise, proceeding to step (15); (13) allowing the hard disk device to be accessed; (14) loading a main operation system of the portable computer, and ending the steps; and (15) locking the main operation system of the portable computer, and ending the steps.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a schematic diagram of an electronic anti-thief lock connecting to an USB port of a notebook;

FIG. 2 is a framework diagram of an embedded anti-thief system according to the present invention;

FIG. 3 is a schematic framework diagram of a core firmware module and an embedded system module installed in a portable computer;

FIGS. 4A, 4B and 4C are flow charts of an anti-thief method for the embedded anti-thief system according to the present invention;

FIG. 5 is a detailed flow chart of step (403);

FIG. 6 is the detailed flow chart of step (407);

FIG. 7 is the detailed flow chart of step (409); and

FIGS. 8A and 8B are the detailed flow chart of step (411).

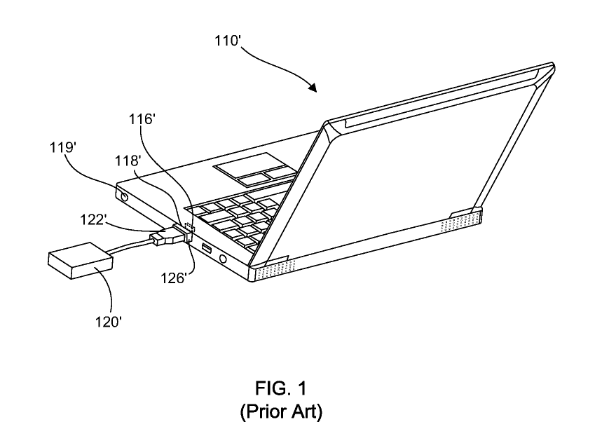

### DETAILED DESCRIPTION OF THE INVENTION

To more clearly describe an embedded anti-thief system and an anti-thief method thereof according to the present invention, embodiments of the present invention will be described in detail with reference to the attached drawings hereinafter.

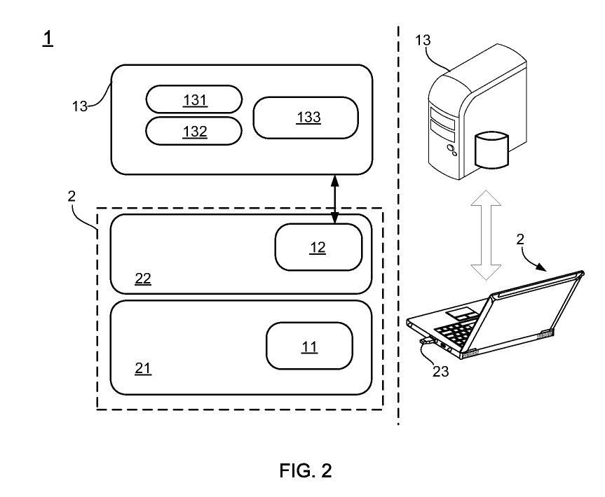

Please refer to FIG. 2, which illustrates a framework diagram of an embedded anti-thief system according to the present invention. As shown in FIG. 2, the embedded anti-thief system 1 of the present invention includes: a core firmware module 11, an embedded system module 12 and a cloud server module 13, wherein the core firmware module 11 is disposed in a firmware device 21 of the portable computer 2, which is an embedded application module. When the portable computer 2 is booted, the core firmware module 11 immediately establishes a Run-Time interface in the firmware device 21, and executes a first step inspection for the security status of the portable computer 2 at the same time, so as to confirm the present security status of the portable computer 2. In the embodiment of the embedded anti-thief system 1, the firmware device 21 of the portable computer 2 is a Basic Input/Output System (BIOS). Thus, when the portable computer 2 is booted, the core firmware module 11 would arrange an operation environment, and divide a storing zone of an extended firmware device 23 connecting with the portable computer 2 to a virtual firmware zone.

Referring to FIG. 2 again, the embedded system module 12 disposed in the portable computer's hard disk device 22 or an embedded system module in the extended firmware device 23. When executing the first step inspection for the portable computer 2, the embedded system module 12 would be immediately loaded and executed if the core firmware module 11 inspects that the portable computer 2 is in an insecurity status. Moreover, for the embodiment of the embedded anti-thief system 1, because the embedded system module 12 is stored in an independent storing space of the hard disk device 22, only one independent storing space can be accessed during the same period of accessing time; for this reason, the embedded system module 12 would not be access by a main operation system of the portable computer when it is in an accessed status. The cloud server module 13 is able to communicate with the embedded system module 12 through the Internet, wherein when the portable computer 2 is in the insecurity status, the embedded system module 12 immediately unloads an IP data, a GPS data, an important backup data, a video data, and a local time data of the portable computer 2 to the cloud server module 13.

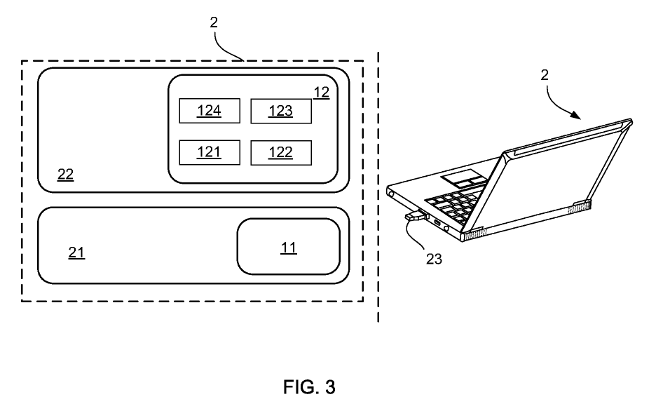

With reference to FIG. 2, and simultaneously referring to FIG. 3, which illustrates schematic framework diagram of the core firmware module and the embedded system module installed in the portable computer. As shown in FIG. 3, the embedded system module 12 installed in the portable computer 2 includes: a Run-Time server module 124, a network inspecting application 121, a video device driving application 123, and a network hardware driving application 122, wherein the Run-Time server module 124 (stored in the hard disk device 22) is able to communicate with the Run-Time interface, so as to receiving the result of the first step inspection for the portable computer 2. The network inspecting application 121 is used to inspect the network status of the portable computer 2 for determining whether the portable computer 2 connects to the Internet; furthermore, the network inspecting application 121 uploads the IP data to the cloud server module 13 when being aware of the international position (IP) of the portable computer 2; after that, the cloud server module 13 returns a verification code to the embedded system module 12, then, the embedded system module 12 executes a second step inspection for the security status of the portable computer 2.

Continuously referring to FIG. 2 and FIG. 3, the video device driving application 12 is adopted to drive a video device of the portable computer 2; so that, the when the portable computer 2 is in the insecurity status, the video device is able to automatically capture the image of a user who is operating the computer, so as to subsequently upload the video data. The network hardware driving application 122 is adopted for driving a network card device of the portable computer 2, thus, regardless of the user surfs Internet via the network card device built in the portable computer 2, or through a mobile internet device (MID) connected to the portable computer 2, for instance, a 3.5 G mobile network card, the network hardware driving application 122 all may drive them, so that the embedded system module 12 is able to communicate with the cloud server module 13 through network card device or the mobile internet device.

Referring to FIG. 2 again, the cloud server module 13 further includes: a Web server 131, an FTP server 132 and an IP database 133, wherein the Web server 131 provides users to login; so that, the users can make commands to the portable computers 2 thereof through the Web server 131 when the portable computers 2 has been stolen. The FTP server 132 is adopted for receiving the IP data, the GPS data, the important backup data, the video data, and the local time data of the portable computer 2 transmitted by the embedded system module 12. The IP database 133 includes an IP address/real address corresponding database, and is able to record the IP data and the local time data when the embedded system module 12 uploads them.

In the embodiment of the embedded anti-thief system 1, after the embedded system module 12 uploads the IP data, the important backup data and the local time data to the cloud server module 13, the cloud server module 13 would return the verification code to the embedded system module 12, and then the embedded system module 12 executes the second step inspection for the security status of the portable computer 2; at the meantime, if the embedded system module 12 inspects that the portable computer 2 is in the security status, the hard disk device is allowed to be accessed and the main operation system of the portable computer 2 is loaded; On the contrary, if the embedded system module 12 inspects that the portable computer 2 is in the insecurity status, not only the access limitation of the hard disk 22 is unable to be released, but also the main operation system of the portable computer is locked. Herein, what must especially to be mentioned is that, in order to make the embedded anti-thief system 1 automatically operates with the start of the portable computer 2, the core firmware module 11 must be store (or installed) in the main firmware of the portable computer 2, for example, BIOS; so that, when the portable computer is booted, the core firmware module 11 can immediately execute anti-thief procedures.

Thus, through the above descriptions, the framework and the functions of the embedded anti-thief system 1 have been clearly disclosed. Furthermore, an anti-thief method for the embedded anti-thief system will be introduced, so as to more clearly describe how the embedded anti-thief system 1 executes the anti-thief procedures thereof.

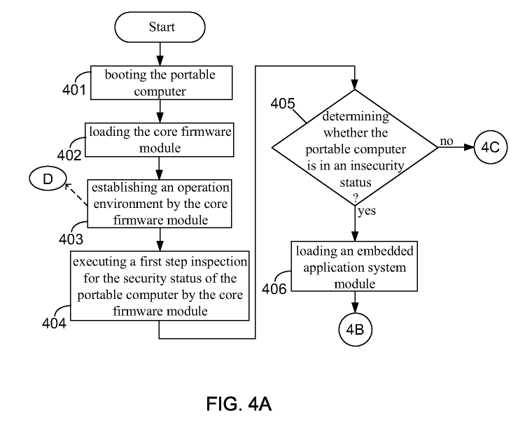

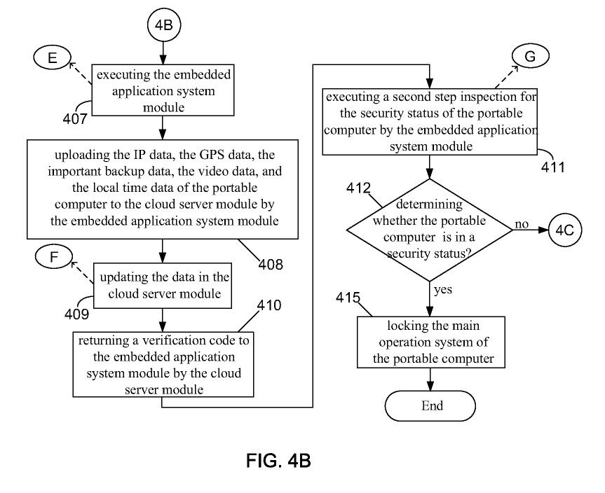

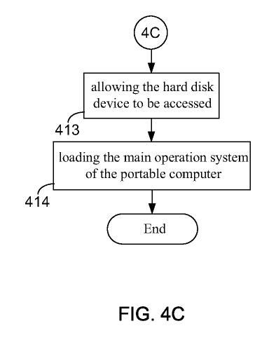

Please refer to FIG. 4A, FIG. 4B and FIG. 4C, which illustrate flow charts of the anti-thief method for the embedded anti-thief system according to the present invention. The anti-thief method for the embedded anti-thief system, comprising the steps of:

Firstly, executing step (401), booting the portable computer 2; next proceeding to step (402), loading the core firmware module 11, and then proceeding to step (403), establishing an operation environment by the core firmware module 11. After the operation environment is established, the flow is proceeded to step (404), executing a first step inspection for the security status of the portable computer 2 by the core firmware module 11; and then proceeding to step (405), determining whether the portable computer 2 is in an insecurity status, if yes, proceeding to step (406), loading an embedded system module 12.

After the step (406) is completed, the flow is proceeded to step (407), executing the embedded system module 12. Next proceeding to step (408), uploading the IP data, the GPS data, the important backup data, the video data, and the local time data of the portable computer 2 to the cloud server module 13 by the embedded system module 12. After that, proceeding to step (409), updating the data in the cloud server module 13, and then executing step (410), returning a verification code to the embedded system module 12 by the cloud server module 13.

After the embedded system module 12 receives the verification code, the flow is proceeded to step (411), executing a second step inspection for the security status of the portable computer 2 by the embedded system module 12, and then proceeding to step (412), determining whether the portable computer 2 is in a security status, if yes, proceeding to step (415), locking the main operation system of the portable computer 2 and subsequently ending the steps of the flow. Moreover, in the determining steps of (405) and (412), if the determining result is “no”, then the flow proceeds to step (413), allowing the hard disk device 2 to be accessed, and subsequently executing step (414), loading the main operation system of the portable computer 2.

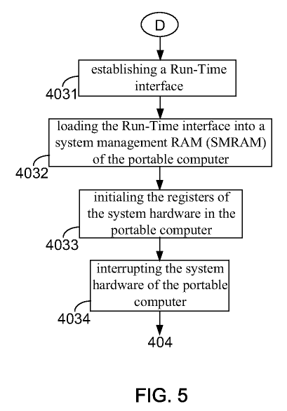

Moreover, in the proceeding flows of the anti-thief method described above, wherein the step (403) further includes detailed steps thereof. Please refer to FIG. 5, which illustrates a detailed flow chart of the step (403), and as shown in FIG. 5, the step (403) includes the detailed steps of:

Firstly, executing step (4031), establishing a Run-Time interface. The flow is next proceeded to step (4032), loading the Run-Time interface into a system management RAM (SMRAM) of the portable computer 2. Then proceeds to step (4033), initialing the registers of the system hardware in the portable computer 2; and finally, executing step (4034), interrupting the system hardware of the portable computer 2. So that, after the step (4034) is completed, the flow of the anti-thief method can be proceeded to the step (404).

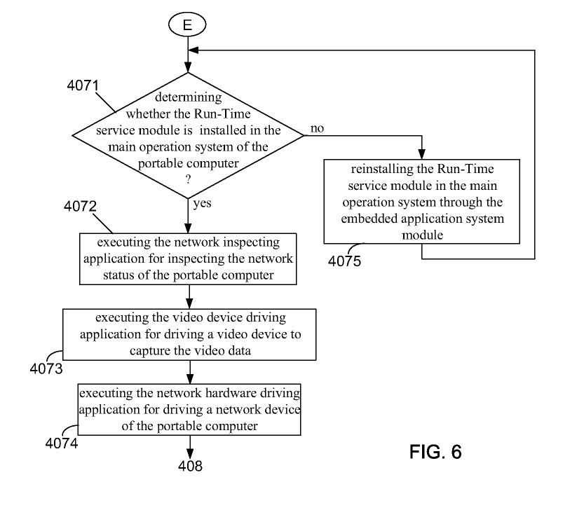

Besides, in the proceeding flows of the anti-thief method described above, wherein the step (407) further includes detailed steps thereof. Please refer to FIG. 6, which illustrates the detailed flow chart of the step (407), and as shown in FIG. 6, the step (407) includes the detailed steps of:

Firstly, executing step (4071), determining whether the Run-Time service module 124 is installed in the main operation system (the hard disk 22) of the portable computer 2, if yes, proceeding to step (4072), executing the network inspecting application 121 for inspecting the network status of the portable computer 2. The flow next proceeds to step (4073), executing the video device driving application 123 for driving a video device to capture the video data, and then proceeds step (4074), executing the network hardware driving application 122 for driving a network device of the portable computer 2 and subsequently executing the step (408). In the determining step of (4071), if the determining result is “no”, then the flow is proceeded to step (4075), reinstalling the Run-Time service module 124 in the main operation system through the embedded system module 12, and proceeding back to the step (4071).

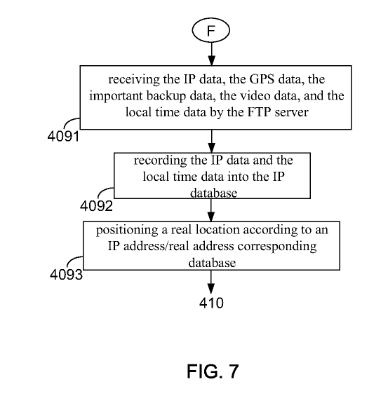

Moreover, please refer to FIG. 7, which illustrates the detailed flow chart of the step (409). In the proceeding flows of the anti-thief method described above, wherein the step (409) further includes three detailed steps of:

First, executing step (4091), receiving the IP data, the GPS data, the important backup data, the video data, and the local time data by the FTP server 132. The flow next proceeds to step (4092), recording the IP data and the local time data into the IP database 133; and finally, executing step (4093), positioning a real location according to an IP address/real address corresponding database. After that, the flow of the anti-thief method can be subsequently proceeded to the step (410).

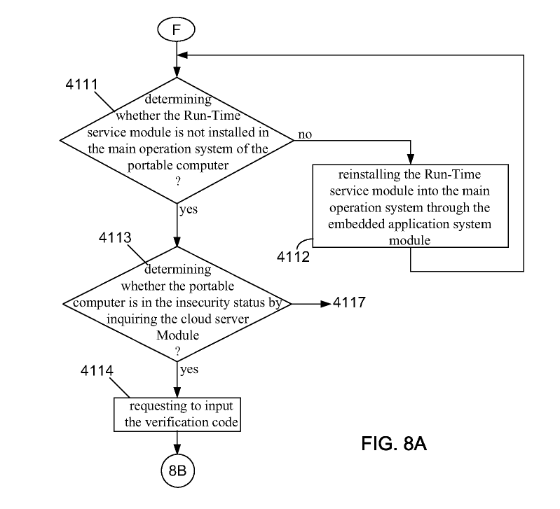

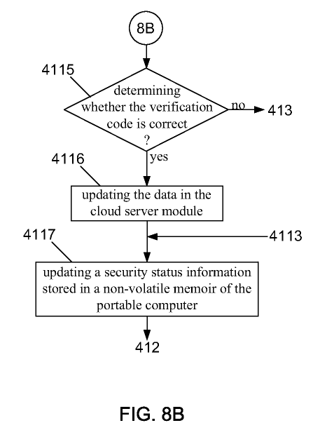

In addition, referring to FIG. 8A and FIG. 8B, which illustrate the detailed flow chart of step (411). In the anti-thief method, the step (411) further includes the detailed steps of:

Firstly, executing step (4111), determining whether the Run-Time service module 124 is not installed in the main operation system of the portable computer 2, if yes, proceeding to step (4112), reinstalling the Run-Time service module 124 into the main operation system through the embedded system module 12, and proceeding back to the step (4111). However, when the determining result of the step (4111) is “no”, the flow is proceeded to step (4113), determining whether the portable computer 2 is in the insecurity status by inquiring the cloud server module 13, if yes, proceeding to step (4114), requesting to input the verification code, and subsequently executing step (4115), determining whether the verification code is correct, if yes, proceeding to step (4116), updating the data in the cloud server module 13, and subsequently executing step (4117), updating a security status information stored in a non-volatile memoir of the portable computer 2; if no, proceeding back to the step (4113). Besides, when the determining result of the step (4113) is “no”, the flow is directly proceeded to the step (4117).

Through the framework of the embedded anti-thief system and the flow charts of the anti-thief method, it is able to know that, users must to register the information of the present security status of the portable computers thereof in the cloud server module 13 when they first time use the embedded anti-thief system, for example, the IP data of the portable computer, wherein when the information of the security status of the portable computers are register in the cloud server module 13, the same information would be simultaneously stored in the non-volatile memory. So that, once a registered portable computer 2 is stolen and departs from the IP zone of the registered IP data, the cloud server module 13 would double confirm whether the IP data registered in the IP database is the same to the IP data stored in the non-volatile memory, and request the present user of the portable computer 2 to input a verification code for determining if the portable computer has been thieved. Moreover, when the portable computer 2 is booted, the core firmware module 11 and the embedded system module 12 are immediately executed and communicated with the cloud server module 13, so as to monitor and determine whether the portable computer leaves the IP zone of the registered IP data without reason; thus, by this way, the portable computers can be protected from theft at any time.

Thus, through the above descriptions, the embedded anti-thief system and the anti-thief method thereof of the present invention have been disclosed completely and clearly in the above description. In summary, the present invention has the following advantages:
1. Since the core firmware module is stored in the firmware of the portable computer and used for controlling the embedded system module to communicate with the cloud server module, the core firmware module is dependent and not relying on the specific operation system.
2. Inheriting to above point 1, because the core firmware module is stored in the firmware of the portable computer, the embedded anti-thief system is the system with the cross platform property; moreover, by way of the communication of the core firmware module and the embedded system module, the firmware device and the hardware device of the portable computer are tightly integrated.
3. The embedded system module includes the network hardware driving application, so that, regardless of the user surfs Internet via the network card device built in the portable computer, or through a mobile internet device (MID) connected to the portable computer, the network hardware driving application 122 all may drive them; For this reason, it is easily to know that the embedded anti-thief system of the present invention has no dependence on the specific network card.
4. Compared with the conventional computer anti-thief device, the embedded anti-thief system of the present invention is able to monitor and determine whether the portable computer leaves the IP zone of the registered IP data without reason, such that the portable computers is prevent from theft at any time.

The above description is made on embodiments of the present invention. However, the embodiments are not intended to limit scope of the present invention, and all equivalent implementations or alterations within the spirit of the present invention still fall within the scope of the present invention.

We claim:

1. An embedded anti-thief system, capable of being installed in a portable computer, comprising:
a core firmware module, being disposed in a firmware device of the portable computer, wherein when the portable computer is booted, the core firmware module being able to execute a first step inspection for the security status of the portable computer;
an embedded system module, being disposed in a hard disk device and an extended firmware device of the portable computer, wherein when the core firmware module inspects that the portable computer is in an insecurity status, the embedded system module being immediately loaded and executed; and
a cloud server module, being able to communicate with the embedded system module through the Internet, wherein when the portable computer is in the insecurity status, the embedded system module immediately unloading an IP data, a GPS data, an important backup data, a video data, and a local time data of the portable computer to the cloud server module, after that the cloud server module returning a verification code to the embedded system module, then, the embedded system module executing a second step inspection for the security status of the portable computer.

2. The embedded anti-thief system of claim 1, wherein when the portable computer is booted, the core firmware module establishing a Run-Time interface in the firmware device, and simultaneously executing the first step inspection.

3. The embedded anti-thief system of claim 1, wherein the embedded system module further comprises:
a Run-Time service module, being connected to the Run-Time interface for receiving the result of the first step inspection;
a network inspecting application, being used to inspect an internet status of the portable computer;
a video device driving application, being adopted to drive a video device of the portable computer, so as to make the video device able to capture the video data; and
a network hardware driving application, being adopted for driving a network card device of the portable computer.

4. The embedded anti-thief system of claim 1, wherein the cloud server module 13 further comprises:
a Web server, providing users to login, so as to make commands to the portable computer has been thieved through the Web server;
an FTP server, receiving the IP data, the GPS data, the important backup data, the video data, and the local time data of the portable computer; and
an IP database, being able to record the IP data and the local time data, and having an IP address/real address corresponding database.

5. The embedded anti-thief system of claim 1, wherein when the second step inspection tests that the portable computer is in the security status, the hard disk device is allowed to be access and a main operation system being loaded.

6. The embedded anti-thief system of claim 1, wherein the firmware device is a Basic Input/Output System (BIOS).

7. The embedded anti-thief system of claim 1, wherein the extended firmware device is selected from the group consisting of: a flash drive, an external hard disk and a memory card.

8. An anti-thief method for an embedded anti-thief system, comprising the steps of:
(1) booting a portable computer;
(2) loading a core firmware module;
(3) establishing an operation environment by the core firmware module;
(4) executing a first step inspection for the security status of the portable computer by the core firmware module;
(5) determining whether the portable computer is in an insecurity status, if yes, proceeding to step (6), otherwise, proceeding to step (13);
(6) loading an embedded system module;
(7) executing the embedded system module;
(8) uploading an IP data, a GPS data, an important backup data, a video data, and a local time data of the portable computer to a cloud server module by the embedded system module;
(9) updating the data in the cloud server module;
(10) returning a verification code to the embedded system module by the cloud server module;
(11) executing a second step inspection for the security status of the portable computer by the embedded system module;
(12) determining whether the portable computer is in a security status, if yes, proceeding to step (13), otherwise, proceeding to step (15);
(13) allowing the hard disk device to be accessed;
(14) loading a main operation system of the portable computer, and ending the steps; and
(15) locking the main operation system of the portable computer, and ending the steps.

9. The anti-thief method for the embedded anti-thief system of claim 8, wherein the step (3) further comprises the detailed steps of:
(31) establishing a Run-Time interface;
(32) loading the Run-Time interface into a system management RAM (SMRAM) of the portable computer;
(33) initialing the registers of the system hardware in the portable computer; and
(34) interrupting the system hardware of the portable computer.

10. The anti-thief method for the embedded anti-thief system of claim 8, wherein the step (7) further comprises the detailed steps of:
(71) determining whether a Run-Time service module is installed in the main operation system of the portable computer, if yes, proceeding to step (72), otherwise, proceeding to step (75);
(72) executing a network inspecting application for inspecting the network status of the portable computer;
(73) executing a video device driving application for driving a video device to capture the video data;
(74) executing a network hardware driving application for driving a network device of the portable computer, and executing the step (8); and
(75) reinstalling the Run-Time service module in the main operation system through the embedded system module, and proceeding back to the step (71).

11. The anti-thief method for the embedded anti-thief system of claim 8, wherein the step (9) further comprises the detailed steps of:
(91) receiving the IP data, the GPS data, the important backup data, the video data, and the local time data by a FTP server;
(92) recording the IP data and the local time data into an IP database; and
(93) positioning a real location according to an IP address/real address corresponding database.

12. The anti-thief method for the embedded anti-thief system of claim 10, wherein the step (11) further comprises the detailed steps of:
(111) determining whether the Run-Time service module is not installed in the main operation system of the portable computer, if yes, proceeding to step (112), otherwise, proceeding to step (113);
(112) reinstalling the Run-Time service module into the main operation system through the embedded system module, and proceeding back to the step (111);
(113) determining whether the portable computer is in the insecurity status by inquiring the cloud server module, if yes, proceeding to step (114), otherwise, proceeding to step (117);
(114) requesting to input the verification code;
(115) determining whether the verification code is correct, if yes, proceeding to step (116), otherwise, proceeding back to the step (113);
(116) updating the data in the cloud server module; and
(117) updating a security status information stored in a non-volatile memoir of the portable computer.
